(19) United States
(12) Patent Application Publication
(10) Pub. No.: US 2022/0174923 A1
(43) Pub. Date: Jun. 9, 2022

(54) Odor-Bearing Soft Bait Fishing Lure

(71) Applicant: Christopher J. DiModica, Holliston, MA (US)

(72) Inventor: Christopher J. DiModica, Holliston, MA (US)

(21) Appl. No.: 17/544,372

(22) Filed: Dec. 7, 2021

Related U.S. Application Data
(60) Provisional application No. 63/122,114, filed on Dec. 7, 2020.

(51) Int. Cl. A01K 85/01; A01K 85/18

(52) U.S. Cl. CPC A01K 85/01; A01K 85/18

(57) ABSTRACT

An odor-bearing soft bait fishing lure with a core with a number of holes in it. The core includes a fish-attractant substance. An outer shell encases the core. The shell has at least one opening that exposes the core to the water when the lure is used in the water, to thereby expose the fish-attractant substance of the core to the water.

### CROSS-REFERENCE TO RELATED APPLICATION

This application claims priority of Provisional Application 63/122,114 filed on Dec. 7, 2020.

### BACKGROUND

This disclosure relates to fishing lure.

Fishing lures are sometimes sprayed or rubbed with a fish attracting agent. The agent easily washes off, necessitating frequent re-application of the attractant.

### SUMMARY

The present soft bait fishing lure is a “odor-bearing” lure that is ready for use out of the package. This lure will prevent the user from having to purchase a separate spray or rub that needs to be added to a bait to achieve the same fish attracting qualities.

Not only will the purchase of a fish attracting agent no longer be necessary, but the storage of the scented agent will also be eliminated. Scented sprays and rubs take up storage space in the user's tackle box and are prone to leak. This can lead to an unpleasant and unsanitary condition in the tackle box that can also cause damage to other lures or tools stored with the agent if it leaks.

The inventive odor-bearing soft bait encapsulates a fish attractant inside the body of the bait. The encapsulated attractant is exposed to the water through openings such as “ridge vents” along the side or top of the bait (depending on the mold application). The encapsulated attractant will also allow for a prolonged fish attracting capability as the bait is submerged in the water.

The subject bait improves upon fishing lures that are considered odor-bearing lures, which are often coated with additional fish attracting materials that are separate from the bait itself and in the form of a liquid spray or rub. Though these fish attractants which are added to a lure can be effective in increasing the chance of a strike, they lack the ability to maintain their efficacy, often dissipating the odor-attracting abilities shortly after entering the water. The inventive odor-bearing soft bait lure will provide the user with a prolonged release of the fish attractant while the bait is submerged in the water and maintain the chumming effect as it sinks into deeper areas where target fish are often found during certain conditions.

In one aspect an odor-bearing soft bait fishing lure includes a porous core with a number of holes in it, wherein the core comprises a fish-attractant substance, and an outer shell that encases the core, wherein the shell has at least one opening that is configured to expose the core to the water when the lure is used in the water, to thereby expose the fish-attractant substance of the core to the water.

In some examples the core further comprises an inner cavity. In an example the core has a plurality of holes. In an example at least some of the holes in the core reach the inner cavity. In an example the inner cavity contains a fish-attractant substance. In an example the fish-attractant substance of the core comprises a liquid.

In an example wherein the core and the outer shell are made from plastisol or another soft plastic.

In some examples the outer shell comprises a plurality of first sections that define solid outer surfaces. In an example the outer shell further comprises an intermediate section that connects two of the first sections that define solid outer surfaces, wherein the intermediate section defines at least one opening. In an example the intermediate section comprises a plurality of spaced bands that interconnect adjoining first sections, to define openings between the bands.

In another aspect an odor-bearing soft bait fishing lure includes a porous core that comprises a body with an outside and a longitudinal inner cavity, and a plurality of holes through the body from the outside of the body and that reach the inner cavity, wherein a fish-attractant substance is in the inner cavity and an outer shell that encases the core, wherein the outer shell is made from a soft plastic material and comprises a plurality of first sections that define solid outer surfaces and an intermediate section that connects two of the first sections that define solid outer surfaces, wherein the intermediate section comprises a plurality of spaced bands that interconnect adjoining first sections, to define openings between the bands that are configured to expose the core to the water when the lure is used in the water, to thereby expose the fish-attractant substance of the core to the water.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a side view of an odor-bearing soft bait fishing lure.

FIG. 2A is a similar view of the body of the lure of FIG. 1.

FIG. 2B is a side view of the core of the lure of FIG. 1.

FIG. 3A is a cross-section taken along line 3A-3A, FIG. 1.

FIG. 3B is a cross-section taken along line 3B-3B, FIG. 1.

FIG. 4 is a side view of an alternative body for an odor-bearing soft bait fishing lure.

FIG. 5 is a side view of a stick bait style odor-bearing soft bait fishing lure rigged with a hook

FIG. 6 is a side view of a Super Fluke style odor-bearing soft bait fishing lure.

FIG. 7 is a side view of a BB Cricket style odor-bearing soft bait fishing lure.

FIG. 8 is a side view of a Craw Bug style odor-bearing soft bait fishing lure.

### DETAILED DESCRIPTION

Examples of the systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The odor-bearing soft bait is a soft body (e.g., made of plastisol) fishing lure that is considered a “odor-bearing” lure. The odor bearing feature includes a core that is molded separately, marinated and impregnated with fish attracting agents. The core can be made of a soft plastic such as plastisol. The soft plastisol body of the lure, which is customizable to any desired form and color, is then molded around the core, making a soft fishing bait that can be rigged to the user's hook and line by any preferred method. The odor-bearing capabilities of the lure will be slowly released as the bait is fished, increasing the chances for a strike.

The odor-bearing soft bait lure is an artificial bait comprised of two major components, both of which are preferably constructed of soft plastic materials. An additional component of a fish attracting liquid, gelatinous, or powder, depending on the application of and conditions in which the bait will be cast, used in conjunction with the two major components, will increase the appeal of the lure to fish, and increase the chances of a strike on the lure.

The first major component is the core itself. This component of the lure is constructed of a soft plastic (e.g., plastisol). In some examples the core is cast in a tube shape with a hollow cavity in the center. After being cast, the core is perforated (in some examples along the entire length of the core). In some examples the core is then soaked or marinated in a liquid fish attractant, which will allow the core body to absorb some of the fish attractant and thus itself possess fish-attracting properties. In some examples the core has a hollow interior that can then be filled or injected with the fish attractant material suitable for the fishing application. In some examples the core is both marinated in fish attractant and includes fish attractant in an interior space that is opened to the water via holes through the core. In other examples the core is either marinated or it includes an interior space that holds fish attractant substance. The injected fish attractant will then leach through the perforated holes of the body and “chum” the immediate area around the lure as it is submerged in the water, increasing the chances of a fish striking the lure.

The second major component of the lure is the outer body or shell which is also constructed of soft (e.g., plastisol) plastic material and can be molded into any variety of custom colors and shapes including but not limited to a worm (e.g., stick bait), crawfish, jitter bug, frog, bait fish or any other traditionally used molds. A key feature of any of these molds will include one or more openings in the outer body (e.g., “ridge vents”) that will allow the core, as described above, to be exposed to the water along the body of the outer shell after it is inserted into the body of the shell. This outer shell will provide the lure with more stability and make it more durable, allowing the bait to be used multiple times before being discarded. By only exposing some of the core to the water, the outer shell will also allow the core to maintain a slower release of the fish attractant as the lure is fished. The wide variety of molding options will allow the user to rig the lure to the desired fishing style.

The core will be inserted into the outer shell by being placed into the casting mold of the outer shell prior to the mold being cast (e.g., by insert molding). The design of the casting mold will allow the outer shell of the bait to form around the core as the shell is being formed inside the mold.

Note that the perforated core could in itself be used as a soft fishing bait. However, it might lack the structural integrity for multiple uses or prolonged exposure to water.

The drawings illustrate non-limiting examples of the inventive odor-bearing soft bait fishing lure.

In some examples the attractant-bearing core is insert molded into the outer shell. The outer shell has one or more openings (three openings, each about 10 mm long in one non-limiting example) that expose the core to the water. In one example there is a 3 mm wide “strap” on each side (thus two diametrically opposed straps) that span the three openings. In another example there are two spaced pairs of diametrically opposed straps. The strap(s) help to maintain the structural integrity of the outer shell. In some examples the core has a number of holes in it or through it laterally; these holes allows the water to get into the core. In some examples the core is soaked in fish attractant. The holes thus allow fish attractant carried by or in the core to dissolve in the water and thus release the scent around the lure, which will attract fish. In some examples but not all the core also has a hollow center (a cavity) that is filled with fish attractant. In this case one or more holes reach this cavity, to cause the release into the water of the attractant in the cavity.

The odor-bearing soft bait lure can be created in any desired lure shape, such as a super fluke, a BB cricket, a craw bug, and a stick bait (worm). Virtually any other form is contemplated. All that is necessary is to have a perforated core and one or more openings in the shell that expose the core to the water.

The subject lure can be rigged in a normal fashion. Rigging of soft bait lures is known in the field and so is not fully disclosed herein.

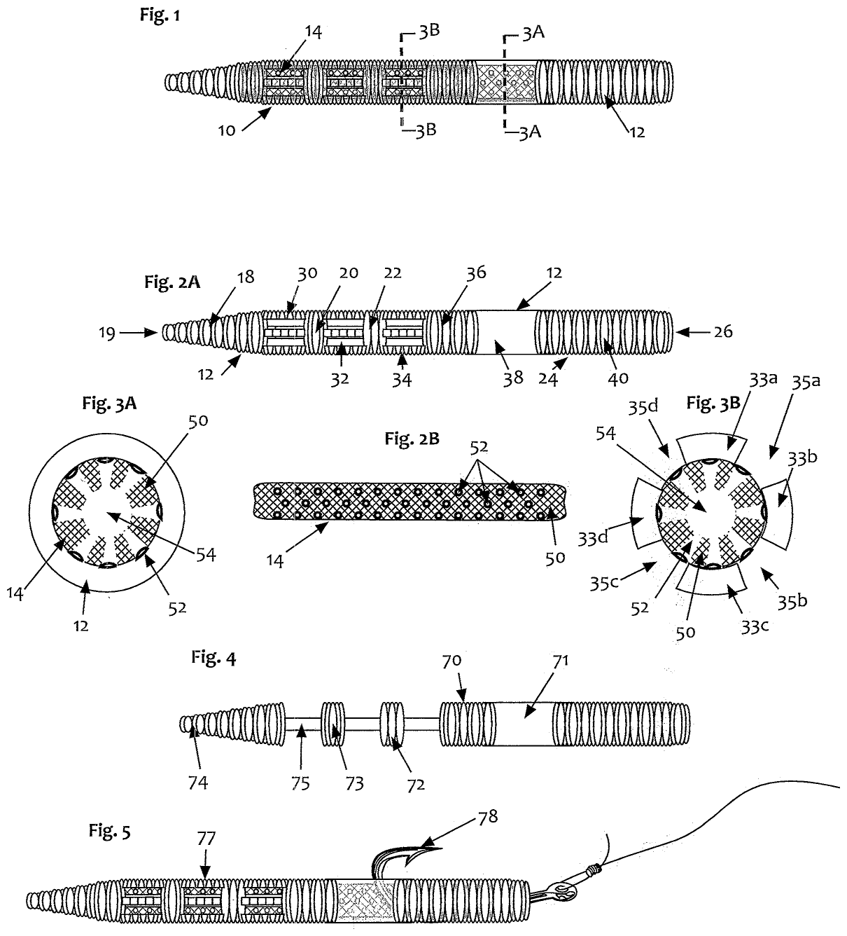

FIG. 1 is a side view of an odor-bearing soft bait fishing lure 10 that includes soft hollow or mostly hollow body 12 and soft core 14 located inside of body 12. FIG. 2A is a similar view of the body 12 of the lure 10 of FIG. 1, but without core 14. Body 12 is molded from a soft plastic such as plastisol.

Body 12 has one or more openings in it that expose core 14 to the outside environment. When lure 10 is in the water, the core is exposed to the water and so the lure releases fish attractant into the water proximate the lure. This helps to attract fish. The opening(s) in the body can be created by any desired means. In some examples openings are created in the molding process, for example with a mold tool that includes solid region(s) on the outside that create areas without molded material that reach to the core. Openings can alternatively be created in a post-molding process such as cutting, punching, or the like.

In the non-limiting example of a stick bait (worm) illustrated in FIGS. 1-3, body 12 comprises forward section 18 with tip 19. Section 18 can be solid and does not include an interior bore or openings. This lends more structural integrity to the lure. Section 30 includes one or more openings, the outside of section 20 is solid (it is annular shaped), section 32 includes one or more openings, the outside of section 22 is solid (annular shaped), section 34 includes one or more openings, and the outsides of sections 36, 38, and 40 are solid. Depending on the length of core 14, some or all of sections 36, 38, and 40 are solid, meaning that they do not have an interior bore.

FIG. 2B is a side view of the core 14 of the lure of FIG. 1. The core carries fish attractant in any manner. In this non-limiting example, and as shown in FIG. 2B and the cross-sections of FIGS. 3A and 3B, core 14 comprises a molded body 50 has a hollow interior 54 that can be partially or fully filled with fish attractant (not shown). Holes 52 that reach from the outer core surface to interior 54 allow the fish attractant to leach through the core and into the water. The size, location, quantity and configuration of holes 52 can be selected to achieve a desired release result. In an example holes 52 are drilled in core 14 or are created in the core molding process.

In some examples the openings in the outside of the body and that expose the core to the water are created by designing the body mold with one or more solid bands that span the distance between adjacent sections that are solid on the outside. For example, sections 20 and 22 are connected by section 32, which includes four solid bands 33a-d that define four openings or windows 35a-d between the bands. The can be any number of bands and thus any number of windows. For example, the embodiment shown in FIG. 4 includes two diametrically opposed bands (only one band 75 visible) rather than four, where the bands connect solid external sections 71, 72, 73, and 74 of body 70.

FIG. 5 is a side view of a stick bait style odor-bearing soft bait fishing lure 77 rigged with a hook 78. Since the lures are soft, they can be pierced by one or more hooks to allow rigging in any known or desired fashion.

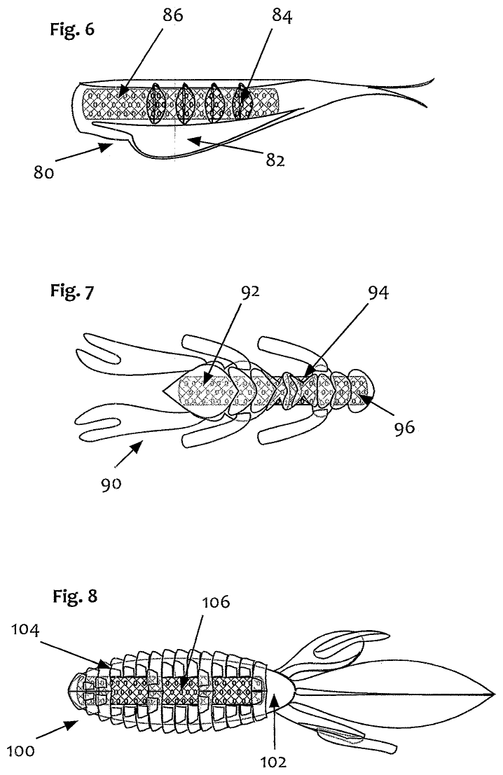

FIG. 6 is a side view of a Super Fluke style odor-bearing soft bait fishing lure 80 with body 82, core 86, and opening(s) 84. FIG. 7 is a side view of a cricket style odor-bearing soft bait fishing lure 90 with body 92, core 96, and opening(s) 94. FIG. 8 is a side view of a craw bug style odor-bearing soft bait fishing lure 100 with body 102, core 106, and opening(s) 104. Any other shape that can be imagined can be molded with body opening(s) to expose the core.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An odor-bearing soft bait fishing lure, comprising:
a porous core with a number of holes in it, wherein the core comprises a fish-attractant substance; and
an outer shell that encases the core, wherein the shell has at least one opening that is configured to expose the core to the water when the lure is used in the water, to thereby expose the fish-attractant substance of the core to the water.

2. The odor-bearing soft bait fishing lure of claim 1 wherein the core further comprises an inner cavity.

3. The odor-bearing soft bait fishing lure of claim 2 wherein the core has a plurality of holes.

4. The odor-bearing soft bait fishing lure of claim 3 wherein at least some of the holes in the core reach the inner cavity.

5. The odor-bearing soft bait fishing lure of claim 4 wherein the inner cavity contains a fish-attractant substance.

6. The odor-bearing soft bait fishing lure of claim 1 wherein the fish-attractant substance of the core comprises a liquid.

7. The odor-bearing soft bait fishing lure of claim 1 wherein the core and the outer shell are made from plastisol or another soft plastic.

8. The odor-bearing soft bait fishing lure of claim 1 wherein the outer shell comprises a plurality of first sections that define solid outer surfaces.

9. The odor-bearing soft bait fishing lure of claim 8 wherein the outer shell further comprises an intermediate section that connects two of the first sections that define solid outer surfaces, wherein the intermediate section defines at least one opening.

10. The odor-bearing soft bait fishing lure of claim 9 wherein the intermediate section comprises a plurality of spaced bands that interconnect adjoining first sections, to define openings between the bands.

11. An odor-bearing soft bait fishing lure, comprising:
a porous core that comprises a body with an outside and a longitudinal inner cavity, and a plurality of holes through the body from the outside of the body and that reach the inner cavity, wherein a fish-attractant substance is in the inner cavity; and an outer shell that encases the core, wherein the outer shell is made from a soft plastic material and comprises a plurality of first sections that define solid outer surfaces and an intermediate section that connects two of the first sections that define solid outer surfaces, wherein the intermediate section comprises a plurality of spaced bands that interconnect adjoining first sections, to define openings between the bands that are configured to expose the core to the water when the lure is used in the water, to thereby expose the fish-attractant substance of the core to the water.
